(19) United States
(12) Patent Application Publication
(10) Pub. No.: US 2025/0314541 A1
(43) Pub. Date: Oct. 9, 2025

(54) METHOD FOR ACQUIRING CORRECTION VALUE FOR TORQUE SENSOR, AND METHOD FOR MEASURING TORQUE OF ROTATING SHAFT

(71) Applicants: NSK LTD., Tokyo (JP); PROTERIAL, LTD., Tokyo (JP)

(72) Inventors: Kota FUKUDA, Takasaki-Shi (JP); Takahiro ODERA, Fujisawa-shi (JP); Takuya SUGIMURA, Fukuroi-shi (JP); Ken OKUYAMA, Tokyo (JP); Naoki FUTAKUCHI, Tokyo (JP)

(73) Assignees: NSK LTD., Tokyo (JP); PROTERIAL, LTD., Tokyo (JP)

(21) Appl. No.: 19/092,403

(22) Filed: Mar. 27, 2025

(30) Foreign Application Priority Data
Apr. 4, 2024 (JP) 2024-060845

(51) Int. Cl. G01L 3/10

(52) U.S. Cl. CPC G01L 3/102

(57) ABSTRACT

The method comprises a step of: actually measuring an output values at a first and second reference temperatures for a torque sensor for which a correction value is to be acquired; determining a provisional correction function, which is a linear function showing a relationship between a temperature and the provisional correction values at the first and second reference temperatures, with using the output values at the first and second reference temperatures as the provisional correction values at the first and second reference temperatures; substituting at least one non-reference temperature into the provisional correction function to obtain a provisional correction value at the non-reference temperature, and correcting the provisional correction value at the non-reference temperature by a correction amount at the non-reference temperature obtained in advance, to obtain a correction value at the at least one non-reference temperature.

### TECHNICAL FIELD

The present disclosure relates to a method for acquiring a correction value for a torque sensor arranged around a detected portion of a rotating shaft, and a method for measuring torque of the rotating shaft.

### BACKGROUND ART

A magnetostrictive torque measuring device is known as a device for measuring the torque applied to a rotating shaft, and that measures torque applied to the rotating shaft by utilizing an inverse magnetostrictive effect that occurs in the rotating shaft when torque is applied to the rotating shaft. A magnetostrictive torque measuring device is configured to measure the torque applied to a rotating shaft by detecting a change in the magnetic permeability of the rotating shaft when torque is applied as a change in inductance of a detection coil.

Generally, the change in magnetic permeability of a detected portion due to fluctuation in torque is very small, and thus usually some measures are taken to improve the measurement sensitivity. As one technique, a method of using a bridge circuit 100 as shown in FIG. 8 is conventionally known. In this method, for example, four detection coils, namely a first detection coil 103, a second detection coil 104, a third detection coil 105, and a fourth detection coil 106, are arranged around a cylindrical detected portion 102, which is a part in the axial direction of a rotating shaft 101 as shown in FIG. 9, and a bridge circuit 100 is formed in which the four detection coils are arranged on the four sides.

When a torque T is applied to the rotating shaft 101, stresses o with opposite signs (+/−) act on an outer peripheral surface of the detected portion 102 in a direction inclined at a predetermined angle (for example, +45 degrees) in a predetermined direction with respect to the axial direction, and in a direction inclined at a predetermined angle (for example, −45 degrees) in a direction opposite to the predetermined direction with respect to the axial direction. Due to the inverse magnetostrictive effect, the magnetic permeability increases in a direction in which a tensile stress (+σ) acts, and decreases in a direction in which a compressive stress (−σ) acts.

In the bridge circuit 100, the first detection coil 103 and the third detection coil 105 arranged on one of the two pairs of opposite sides that make up the four sides are detection coils for detecting changes in magnetic permeability on the outer peripheral surface of the detected portion 102 in a direction inclined at a predetermined angle in a predetermined direction with respect to the axial direction, and the second detection coil 104 and the fourth detection coil 106 arranged on the other pair of opposite sides are detection coils for detecting changes in magnetic permeability on the outer peripheral surface of the detected portion 102 in a direction inclined at a predetermined angle in a direction opposite to the predetermined direction with respect to the axial direction. In such a bridge circuit 100, when an AC voltage (input voltage) Vi is applied between two end points, point A and point C, an output value (output voltage) Vo according to the direction and magnitude of the torque T applied to the rotating shaft 101 is obtained as a voltage between two midpoints, point B and point D. Therefore, the torque T can be obtained based on this output value Vo.

By using the bridge circuit 100 as described above, the output value Vo can be doubled compared to a case in which only a change in magnetic permeability in either one of a direction inclined at a predetermined angle in a predetermined direction with respect to the axial direction and a direction inclined at a predetermined angle in a direction opposite to the predetermined direction with respect to the axial direction is detected, thereby making it possible to improve the measurement sensitivity of the torque T.

Incidentally, it is preferable that the four detection coils 103 to 106 of the bridge circuit 100 all have the same impedance. However, in reality, fluctuations in the impedances of the detection coils 103 to 106 occur due to manufacturing errors and the like. Due to the influence of such fluctuations in impedance, even in a state in which no torque T is applied to the rotating shaft 101, an offset voltage is inevitably output.

It is also known that the impedances of the four detection coils 103 to 106 change due to temperature. Therefore, the offset voltage also fluctuates due to temperature. For this reason, the relationship between the torque T applied to the rotating shaft 101 and the output voltage Vo is also affected by changes in temperature.

JP 2018-048956 A describes a magnetostrictive torque measuring device (torque sensor) capable of detecting torque with high accuracy regardless of temperature changes.

In the conventional torque measuring device described in JP 2018-048956 A, the output value (sine component and cosine component of the output voltage) at a preset reference temperature is stored, and the relationship between the amount of change in output value (change amount in sine component and change amount in cosine component) relative to the temperature change from the reference temperature when no torque is applied to the rotating shaft is also stored. When determining the torque applied to the rotating shaft, the amount of change in the output value corresponding to the temperature detected by a temperature detection method at that time is determined from the above relationship, the output value output from the torque sensor (sensor unit) at that time is corrected using the amount of change, and the torque is calculated based on the corrected output value.

In the conventional torque measuring device described in JP 2018-048956 A, in order to determine the relationship between the amount of change in output value and the temperature change from a reference temperature when no torque is applied to the rotating shaft, it is necessary to perform testing to obtain output values at multiple temperatures for each torque sensor. More specifically, the output value is obtained at regular temperature intervals (for example, 10° C.) within a temperature range in which the torque sensor is normally used (for example, a range of about −40° C. to 120° C.).

More specifically, the torque sensor is placed in a test chamber, the temperature in the test chamber (room temperature) is set to a predetermined temperature, and the torque sensor is left for a certain period of time until the temperature of the torque sensor reaches the predetermined temperature, and then the output value at that temperature is acquired. This procedure is repeated while changing the temperature in the test chamber by a constant temperature within a temperature range in which the torque sensor is normally used.

Such testing requires a considerable amount of time and effort, which may result in problems such as reduced productivity of the torque sensor and increased manufacturing costs.

JP 2023-127315 A describes a manufacturing method that can reduce the manufacturing time of a torque measuring device having a function of compensating for the effects of temperature.

In the manufacturing method described in JP 2023-127315 A, first, a test is performed on a plurality of test samples to examine a coil balance C_{b}, which is the ratio (R1×R3)/(R2×R4) of the product R1×R3 of resistance values R1, R3 of two opposing sides that constitute one pair of opposing sides of the four sides of the bridge circuit to the product R2×R4 of resistance values R2, R4 of two opposing sides that constitute the other pair of opposing sides of the four sides, and the temperature change rate V_{T} of the output value (output voltage) Vo due to temperature fluctuations of the torque sensor (sensor unit), and the relationship X between the coil balance C_{b} and the temperature change rate V_{T} is obtained from the results of the test. Next, for the torque sensor to be manufactured, the resistance values R1, R2, R3, and R4 of the four sides of the bridge circuit are measured to determine the coil balance C_{b}, and the temperature change rate V_{T} of the torque sensor to be manufactured is determined from the relationship X using the coil balance C_{b}.

With the conventional manufacturing method described in JP 2023-127315 A, there is no need to perform tests to acquire output values at multiple temperatures for each individual torque sensor to be manufactured, and thus manufacturing time can be significantly reduced.

### CITATION LIST

### Patent Literature

Patent Document 1: JP 2018-048956 A

Patent Document 2: JP 2023-127315 A

### SUMMARY OF INVENTION

### Technical Problem

In a conventional manufacturing method described in JP 2023-127315 A, testing to obtain actual output values is not performed for each individual torque measuring device to be manufactured, which may make it difficult to ensure torque measurement accuracy.

An object of the technique according to the present disclosure is to provide a method for acquiring a correction value for a torque sensor that can shorten the time required for testing for acquiring a correction value while ensuring the accuracy of torque measurement.

### Solution to Problem

A torque sensor that is the subject of a method for acquiring a correction value for a torque sensor according to an aspect of the present disclosure is arranged around a detected portion of a rotating shaft.

A method for acquiring a correction value for a torque sensor according to an aspect of the present disclosure includes:
measuring an output value at a first reference temperature and an output value at a second reference temperature of the torque sensor for which the correction value is to be acquired;
determining a provisional correction function that is a linear function indicating a relationship between a temperature, and a provisional correction value at the first reference temperature and a provisional correction value at the second reference temperature for the torque sensor for which the correction value is to be acquired, with using an output value at the first reference temperature as the provisional correction value at the first reference temperature and an output value at the second reference temperature as the provisional correction value at the second reference temperature;
substituting at least one non-reference temperature other than the first reference temperature and the second reference temperature into the provisional correction function to obtain a provisional correction value at the at least one non-reference temperature; and
obtaining a correction value at the at least one non-reference temperature by correcting the provisional correction value at the at least one non-reference temperature by a correction amount at the at least one non-reference temperature that has been obtained in advance.

In a method for acquiring a correction value for a torque sensor according to an aspect of the present disclosure,
the correction amount at the at least one non-reference temperature is found by:
actually measuring an output value at the first reference temperature, an output value at the second reference temperature, and an output value at the at least one non-reference temperature for at least one test sample having a same configuration as the torque sensor for which the correction value is to be acquired;
determining a reference function that is a linear function indicating a relationship between a temperature, and a provisional output value at the first reference temperature and a provisional output value at the second reference temperature for the at least one test sample, with using the output value at the first reference temperature as the provisional output value and the output value at the second reference temperature as the provisional output value; and
obtaining a difference between the provisional output value at the at least one non-reference temperature obtained by substituting the at least one non-reference temperature into the reference function, and the actually measured output value at the at least one non-reference temperature.

In a method for acquiring a correction value for a torque sensor according to an aspect of the present disclosure,
an absolute value of a difference between the first reference temperature and the second reference temperature is 10° C. or more and 190° C. or less. The absolute value of the difference between the first reference temperature and the second reference temperature is preferably 60° C. or more and 130° C. or less.

A method for measuring torque of a rotating shaft according to an aspect of the present disclosure includes,
correcting an output value of a torque sensor arranged around a detected portion of the rotating shaft with a correction value determined in advance in accordance with a temperature of the torque sensor; and calculating torque applied to the rotating shaft based on the corrected output value of the torque sensor.

In particular, in the method for measuring torque of a rotating shaft according to an aspect of the present disclosure, the correction value is acquired by a method for acquiring a correction value for a torque sensor according to an aspect of the present disclosure.

### Effect of Invention

With the method for acquiring a correction value for a torque sensor according to an aspect of the present disclosure, it is possible to shorten the time required for testing to acquire the correction value while ensuring the torque measurement accuracy.

### BRIEF DESCRIPTION OF DRAWINGS

FIG. 1 is a perspective view schematically illustrating an example of a torque sensor that is a target of a method for acquiring a correction value for a torque sensor of an example according to an embodiment of the present disclosure.

FIG. 2 is a schematic cross-sectional view of the torque sensor taken along an imaginary plane including the central axis.

FIG. 3 is a diagram of first, second, third and fourth detection coils of the torque sensor as viewed from the outside in the radial direction.

FIG. 4A is an exploded view of the first detection coil alone as viewed from the outside in the radial direction; FIG. 4B is an exploded view of the second detection coil alone as viewed from the outside in the radial direction; FIG. 4C is an exploded view of the third detection coil alone as viewed from the outside in the radial direction; and FIG. 4D is an exploded view of the fourth detection coil alone as viewed from the outside in the radial direction.

FIG. 5 is a diagram schematically illustrating a torque measuring device including the torque sensor.

FIG. 6A is a diagram schematically illustrating the results when the relationship between each temperature and output value was measured for a test sample, and FIG. 6B is a diagram schematically illustrating the correction amount at each temperature.

FIG. 7A is a diagram schematically illustrating the results when the output value at a first reference temperature and the output value at a second reference temperature are measured for a torque sensor for which a correction value is to be acquired, and FIG. 7B is a diagram for explaining a method for acquiring a correction value at a non-reference temperature based on the relationship illustrated in FIG. 7A.

FIG. 8 is a diagram illustrating a bridge circuit of a conventional torque measuring device.

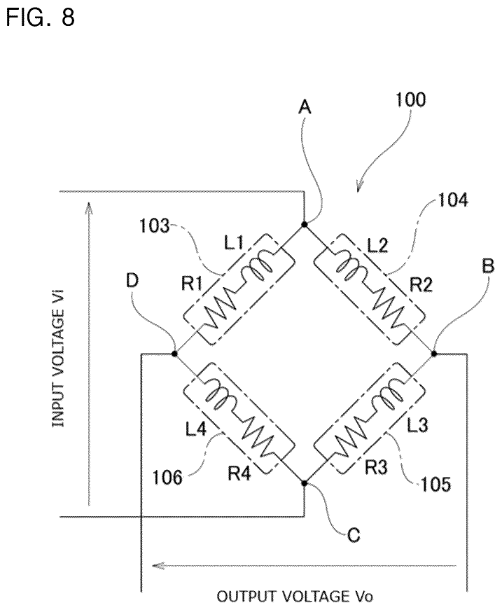

FIG. 9 is a perspective view of a rotating shaft for explaining the direction of stress generated when torque is applied to the rotating shaft.

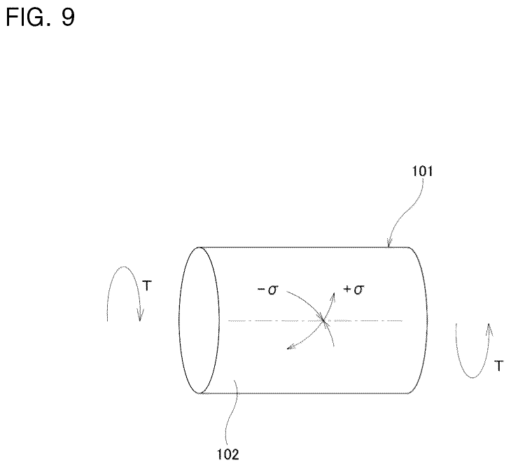

### DESCRIPTION OF EMBODIMENTS

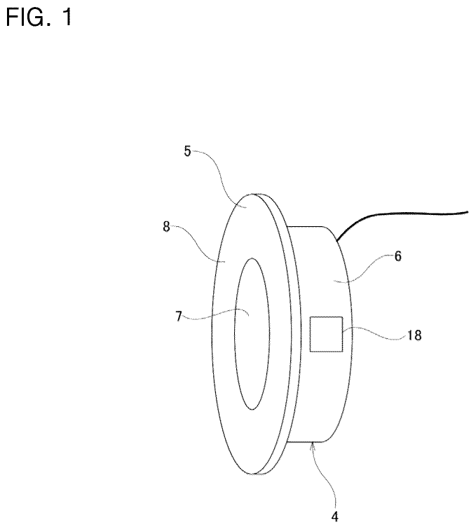

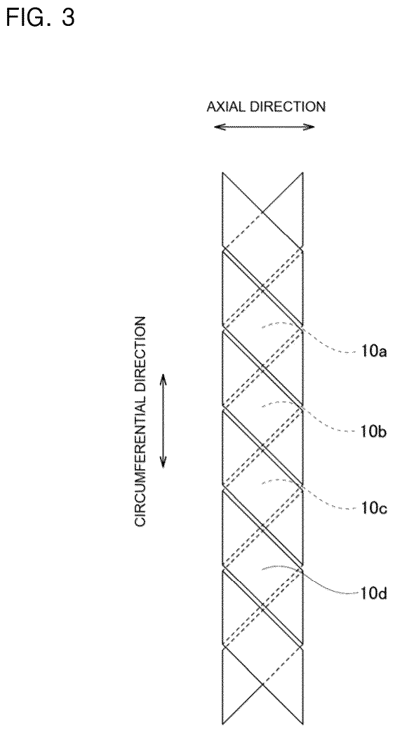

An example of an embodiment according to the present disclosure will be described with reference to FIGS. 1 to 7B.

The method for acquiring a correction value for a torque sensor and a method for measuring torque of a rotating shaft of the present example can be widely applied to magnetostrictive torque measurement devices (torque sensors) that are affected by temperature changes. Below, the structure of the torque measuring device 1, which includes a torque sensor 4 to which the method for acquiring a correction value of the present example can be suitably applied will be explained, after which the method for acquiring a correction value for the torque sensor 4 will be explained, and further a method of detecting torque T applied to the rotating shaft 2 using the torque measuring device 1 will be explained.

### Structure of Torque Measuring Device

The torque measuring device 1 determines magnitude and direction (CW or CCW) of the torque T being transmitted by the rotating shaft 2 by utilizing an inverse magnetostrictive effect occurring in the rotating shaft 2. The torque measuring device 1 has a function of correcting an output value Vo of the torque sensor 4 arranged around a detected portion 3 of the rotating shaft 2 with a correction value C according to the temperature of the torque sensor 4.

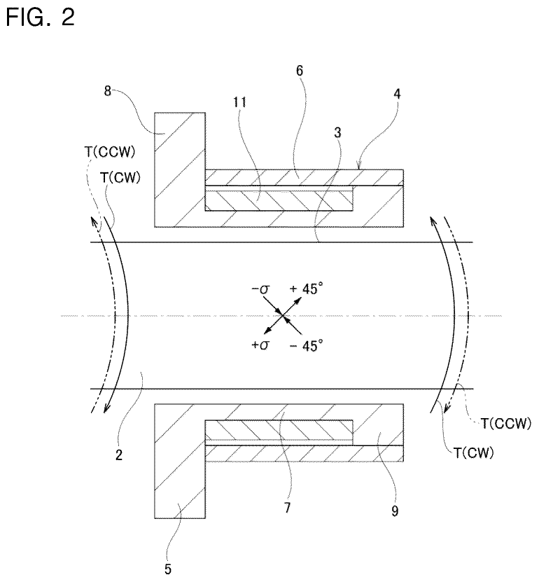

In the following description, the axial direction, radial direction, and circumferential direction of the torque measuring device 1 refer to the axial direction, radial direction, and circumferential direction of the rotating shaft 2, unless otherwise specified. The axial direction, radial direction, and circumferential direction of the rotating shaft 2 coincide with the axial direction, radial direction, and circumferential direction of a holder 5 and also coincide with the axial direction, radial direction, and circumferential direction of a magnetic ring 6. Moreover, one side in the axial direction refers to the left side in FIG. 2, and the other side in the axial direction refers to the right side in FIG. 2.

The rotating shaft 2 has a detected portion 3 on a part of the outer peripheral surface in the axial direction.

Magnetic permeability of the detected portion 3 changes in response to the torque T applied to the rotating shaft 2. In other words, the detected portion 3 exhibits an inverse magnetostrictive effect when torque T is applied to the rotating shaft 2.

The configuration of the detected portion 3 is not particularly limited as long as the magnetic permeability changes with the application of torque T to the rotating shaft 2 and the change in magnetic permeability can be detected by the torque sensor 4. In other words, the detected portion 3 can have a configuration corresponding to the configuration of the torque sensor 4.

In the present example, all four detection coils 10a to 10d of the torque sensor 4 are stacked in the radial direction. Therefore, the detected portion 3 is formed of a cylindrical surface having an outer diameter that does not change in the axial direction. In this case, a modified layer having magnetostrictive characteristics improved by a shot peening process may be provided on a surface layer of the rotating shaft 2 including the detected portion 3.

In addition, a part or the whole of the rotating shaft 2 including at least the detected portion 3 is made of a material having magnetostrictive characteristics. As the material having magnetostrictive properties, either a material having a positive magnetostriction constant or a material having a negative magnetostriction constant can be used. More specifically, a part or all of the rotating shaft 2 can be made of a steel material such as, but not limited to, carbon steel for mechanical construction (SC), stainless steel (SUS), chromium steel (SCr), chromium molybdenum steel (SCM), or nickel chromium molybdenum steel (SNCM). Alternatively, the rotating shaft 2 can be configured by covering a part or all of the rotating shaft 2 including the detected portion 3 with a magnetostrictive film such as a nickel alloy.

Alternatively, in a case in which the torque sensor 4 has two detection coils arranged side by side in the axial direction, the detected portion 3 can be configured by: a first magnetic change portion that is configured by alternately arranging first magnetic parts having magnetic anisotropy and first non-magnetic parts not having magnetic anisotropy in the circumferential direction, each of which is formed so as to extend in a direction inclined at a predetermined angle (for example, +45 degrees) in a predetermined direction with respect to the axial direction; and a second magnetic change portion that is configured by alternately arranging second magnetic parts having magnetic anisotropy and second non-magnetic parts not having magnetic anisotropy in the circumferential direction, each of which is formed so as to extend in a direction inclined at a predetermined angle (for example, −45 degrees) in the opposite direction to the predetermined direction with respect to the axial direction.

The rotating shaft 2 is rotatably supported through a bearing (not illustrated) with respect to a fixed portion that does not rotate even during use.

The torque measuring device 1 includes a torque sensor 4 arranged around the detected portion 3 of the rotating shaft 2. The basic configuration of the torque measuring device 1 including the torque sensor 4 is not particularly limited as long as the torque measuring device 1 is capable of detecting the change in magnetic permeability of the detected portion 3 associated with the application of torque T to the rotating shaft 2.

For example, the torque measuring device 1 can have the same basic configuration as the torque measuring device (torque sensor) described in JP 2018-048956 A or the basic configuration of the torque measuring device described in JP 2023-127315 A.

In the present example, the torque sensor 4 includes a holder 5 and a magnetic ring 6 in addition to the plurality of detection coils 10a to 10d.

The holder 5 has a bobbin portion 7 that is arranged around the detected portion 3 of the rotating shaft 2.

In the present example, the bobbin portion 7 is formed in a cylindrical shape. That is, the bobbin portion 7 has a cylindrical inner peripheral surface having an inner diameter that does not change in the axial direction, and a cylindrical outer peripheral surface having an outer diameter that does not change in the axial direction. However, the bobbin portion may also be configured in partial cylindrical shape.

The holder 5 is supported by and fixed to a fixed portion that does not rotate during use, such as a housing, with the bobbin portion 7 arranged coaxially around the detected portion 3 of the rotating shaft 2. With the holder 5 supported by and fixed to the fixed portion, the inner peripheral surface of the bobbin portion 7 faces the detected portion 3 with a radial gap therebetween.

The holder 5 is made of synthetic resin, which is a non-magnetic and non-conductive (insulating) material. More specifically, the holder 5 is made of a thermoplastic resin such as epoxy resin, polyphenylene sulfide (PPS), polyamide (PA), or polyphthalamide (PPA). In the present embodiment, the holder 5 is integrally formed by injection molding of synthetic resin. However, the holder 5 may also be configured by combining a plurality of parts.

In the present example, the holder 5 includes, as optional elements, a first outward-facing flange portion 8 extending outward in the radial direction from an end portion on the one side in the axial direction of the bobbin portion 7 around the entire circumference, and a second outward-facing flange portion 9 extending outward in the radial direction from an end portion on the other side in the axial direction of the bobbin portion 7 around the entire circumference.

The first outward-facing flange portion 8 has an attachment portion for supporting and fixing the holder 5 to the fixed portion, and a wiring accommodating portion for accommodating cables or signal lines that electrically connect the detection coils 10a to 10d to an external device.

In the present example, the outer diameter of the first outward-facing flange portion 8 is larger than the outer diameter of the second outward-facing flange portion 9. However, the outer diameter of the first outward-facing flange portion 8 may be the same as the outer diameter of the second outward-facing flange portion 9, or may be smaller than the outer diameter of the second outward-facing flange portion 9.

The torque sensor 4 has a plurality of detection coils 10 arranged around the bobbin portion 7.

The number, configuration, and arrangement of the plurality of detection coils 10 are not particularly limited as long as the change in magnetic permeability of the rotating shaft 2 can be detected. For example, the plurality of detection coils 10 can be arranged so as to overlap each other in the radial direction, or can be arranged so as to be aligned in the axial direction, or can be arranged so as to overlap each other in the radial direction and be aligned in the axial direction.

In the present example, the plurality of detection coils 10 are configured by four detection coils 10a to 10d that are arranged overlapping each other in the radial direction. More specifically, the four detection coils 10a to 10d are arranged so as to overlap each other in the order of the first detection coil 10a, the second detection coil 10b, the third detection coil 10c, and the fourth detection coil 10d, from the inner side in the radial direction.

Alternatively, the plurality of detection coils 10 may include two detection coils arranged side-by-side in the axial direction.

In addition, in the present example, the four detection coils 10a to 10d are formed in four wiring layers of the flexible substrate 11. The flexible substrate 11 has a laminated structure having four wiring layers. Each wiring layer comprises a wiring pattern formed by etching a conductor such as copper foil. That is, in the present example, each of the detection coils 10a to 10d is formed by a wiring pattern.

Alternatively, each detection coil 10 can be constructed by winding an insulated wire along a groove formed in an outer peripheral surface of the bobbin portion 7 of the holder 5.

Of the four detection coils 10a to 10d, the first detection coil 10a and the third detection coil 10c detect changes in magnetic permeability in a direction inclined at a predetermined angle (for example, +45 degrees) in a predetermined direction with respect to the axial direction in the detected portion 3. In other words, the first detection coil 10a and the third detection coil 10c change their own inductance in accordance with a change in magnetic permeability in the direction inclined at the predetermined angle in the predetermined direction with respect to the axial direction.

Of the four detection coils 10a to 10d, the second detection coil 10b and the fourth detection coil 10d detect changes in magnetic permeability in a direction inclined at a predetermined angle (for example, −45 degrees) in the opposite direction to the predetermined direction with respect to the axial direction in the detected portion 3. In other words, the second detection coil 10b and the fourth detection coil 10d change their own inductance in accordance with a change in magnetic permeability in the direction inclined at the predetermined angle in the opposite direction to the predetermined direction with respect to the axial direction.

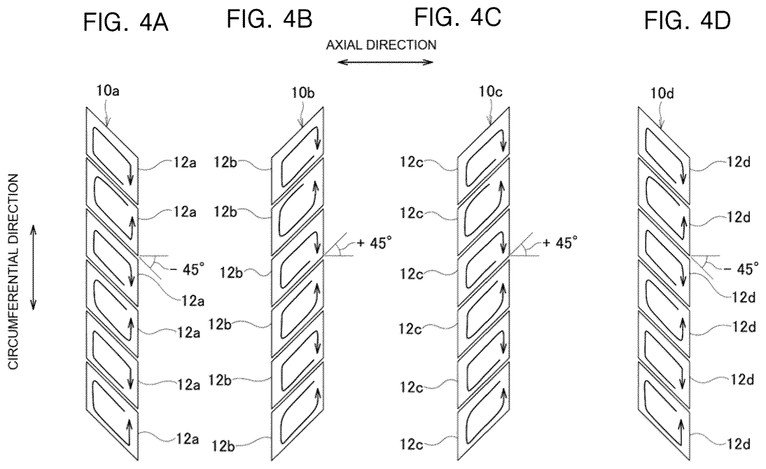

Each of the detection coils 10a to 10d is configured by arranging a plurality of coil pieces 12a to 12d, which are formed by arranging the wiring pattern in a parallelogram shape when viewed in the radial direction, at equal intervals in the circumferential direction, as schematically illustrated in FIGS. 4A to 4D.

The coil piece 12a of the first detection coil 10a and the coil piece 12c of the third detection coil 10c have straight portions inclined at the predetermined angle in the direction opposite to the predetermined direction with respect to the axial direction. The coil piece 12b of the second detection coil 10b and the coil piece 12d of the fourth detection coil 10d have straight portions inclined at the predetermined angle in the predetermined direction with respect to the axial direction.

Note that the coil pieces 12a to 12d are schematically illustrated in FIGS. 4A to 4D. In reality, there is a discontinuous portion in the wiring pattern of the coil pieces 12a to 12d, and the coil pieces 12a to 12d respectively have two end portions that sandwich the discontinuous portion. The coil pieces 12a to 12d that are adjacent in the circumferential direction are respectively connected in series by connecting end portions of each other with a conductor such as a wiring pattern (not illustrated).

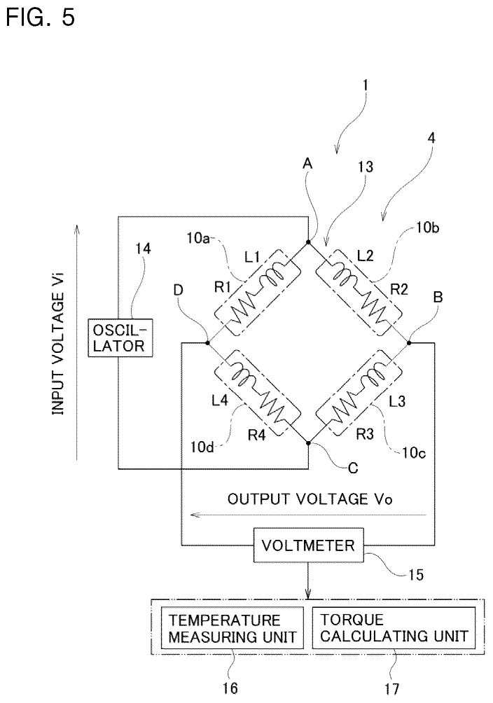

The four detection coils 10a to 10d are connected in a ring shape to form the bridge circuit 13, as illustrated in FIG. 5.

The magnetic ring 6 is also called a back yoke, and has a function of preventing the magnetic flux generated in the detection coils 10 from leaking to the outside. The magnetic ring 6 is made of a magnetic material and is configured as a single unit. The magnetic material of the magnetic ring 6 may be, for example, an iron-based alloy such as alloy steel for machine construction or stainless steel.

The magnetic ring 6 has a cylindrical shape. The magnetic ring 6 is arranged around the detection coils 10 coaxially with the detection coils 10, and is connected and fixed to the holder 5. In the present example, by externally fitting and fixing the end portion on the other side in the axial direction of the magnetic ring 6 to the second outward-facing flange portion 9, the magnetic ring 6 is connected and fixed to the holder 5.

The torque measuring device 1 further includes an oscillator 14, a voltmeter 15, a temperature measuring unit 16, and a torque calculating unit 17. In the present example, the oscillator 14, the voltmeter 15, the temperature measuring unit 16, and the torque calculating unit 17 are provided in the torque measuring device 1 as external devices of the torque sensor 4.

Alternatively, some or all of the oscillator 14, voltmeter 15, temperature measuring unit 16, and torque calculating unit 17 may be provided inside or around the torque sensor 4.

In the present example, the oscillator 14 applies an AC voltage (input voltage) Vi between a contact point A between the first detection coil 10a and the second detection coil 10b and a contact point C between the third detection coil 10c and the fourth detection coil 10d.

The voltmeter 15 detects an output value (output voltage) Vo between a contact point B between the second detection coil 10b and the third detection coil 10c and a contact point D between the first detection coil 10a and the fourth detection coil 10d.

The temperature measuring unit 16 has a function of measuring the temperature of the torque sensor 4, more specifically, the temperature of the detection coils 10 (10a to 10d). The temperature measuring unit 16 can be configured to measure the temperature t of the torque sensor 4 based on the AC voltage Vi applied to the bridge circuit 13, or can be configured by a contact-type thermometer such as a thermocouple or a non-contact-type thermometer such as a radiation thermometer.

In the present example, the temperature measuring unit 16 is configured to measure the temperature t of the torque sensor 4 based on the AC voltage Vi applied to the bridge circuit 13.

The AC voltage Vi applied to the bridge circuit 13 is divided by the internal impedance of the oscillator 14 and the impedance between the contact points A and C. Therefore, when the impedance of the detection coils 10 (10a to 10d) changes with a change in temperature of the torque sensor 4, the AC voltage Vi applied to the bridge circuit 13 also changes. The temperature measuring unit 16 is configured to determine the amount of change (amount of temperature change) Δt of the current temperature of the torque sensor 4 from an arbitrarily set reference temperature t₀, based on the AC voltage Vi applied to the bridge circuit 13.

For this purpose, the temperature measuring unit 16 obtains in advance by calculation, experiment, or the like, the magnitude Vi₀ of the AC voltage at the reference temperature t₀, and the relationship between the amount of temperature change Δt and the amount of change ΔVi of the AC voltage magnitude, and stores these in memory. The temperature measuring unit 16 determines the amount of change ΔVi of the magnitude Vi of the AC voltage input through a lock-in amplifier or the like from the magnitude Vi₀ of the AC voltage at a pre-stored reference temperature t₀, and determines the amount of change (temperature change) Δt of the current temperature t of the torque sensor 4 from the reference temperature t₀ based on the amount of change ΔVi and the above relationship. Then, by adding the amount of change Δt to the reference temperature t₀, the current temperature t (=t₀+Δt) of the torque sensor 4 can be obtained.

Note that in a case in which the lock-in amplifier outputs the sine component and cosine component of the AC voltage, the amount of temperature change can be determined based on the magnitude of the AC voltage found by taking the root mean square of the sine component and cosine component. However, the amount of temperature change can also be obtained based on only the sine component or only the cosine component of the AC voltage.

In the present example, the temperature t of the torque sensor 4 is measured based on the AC voltage Vi applied to the bridge circuit 13, and thus, it is not necessary to provide a temperature sensor just to obtain the temperature t of the torque sensor 4, which makes it easier to reduce the manufacturing cost and reduce the size of the torque measuring device 1.

The torque calculating unit 17 calculates the torque T applied to the rotating shaft 2. The torque calculating unit 17 has a correction function that corrects the output value Vo of the torque sensor 4 with a correction value C that corresponds to the temperature of the torque sensor 4, and a calculation function that calculates the torque T applied to the rotating shaft 2 based on the corrected output value Vc of the torque sensor 4.

In the present example, the correction function corrects the output value Vo of the torque sensor 4 detected by the voltmeter 15 with a correction value C obtained in advance in accordance with the temperature t of the torque sensor 4 measured by the temperature measuring unit 16. A method for determining in advance the correction value C at the temperature t will be described later.

In the present example, the calculation function determines the magnitude T and direction (CW or CCW) of the torque applied to the rotating shaft 2 based on the output value Vc of the torque sensor 4 corrected by the correction function, and the relationship between the output value V, which has been determined in advance by calculation, experiment, or the like, and the magnitude T and direction (CW or CCW) of the torque applied to the rotating shaft 2.

The temperature measuring unit 16 and the torque calculating unit 17 can be implemented on one microcomputer (MCU), for example. However, the temperature measuring unit 16 and the torque calculating unit 17 may be implemented on microcomputers different from each other.

### Method for Acquiring a Correction Value for a Torque Sensor

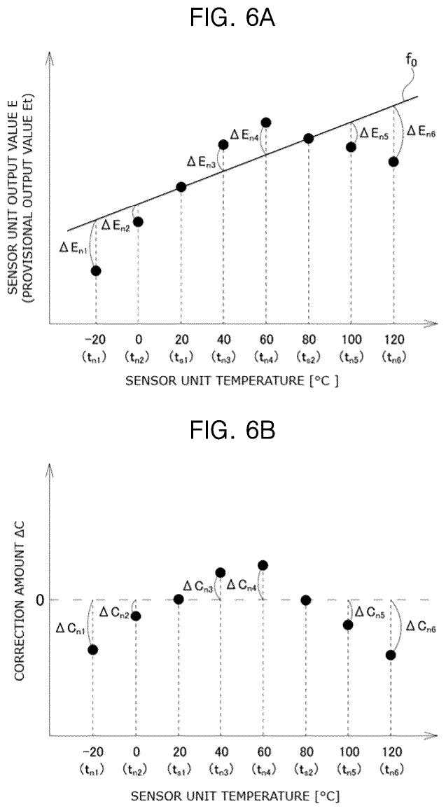

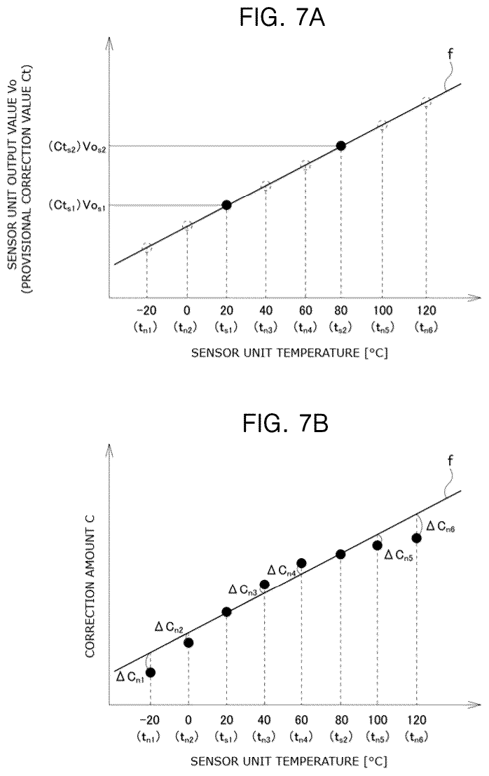

A method for acquiring a correction value for acquiring the correction value C used to correct the output value Vo of the torque sensor 4 will be described with reference to FIGS. 6(A) to 7(B).

In the present example of the method for acquiring a correction value for the torque sensor 4, in order to obtain a correction value C for correcting the output value Vo of the torque sensor 4 for which a correction value is to be acquired, a process is first performed in which an output value Voₛ₁ at a first reference temperature tₛ₁ and an output value Voₛ₂ at a second reference temperature tₛ₂ are actually measured for the torque sensor 4 for which the correction value is to be acquired.

Measurement of the output values Voₛ₁ and Voₛ₂ is performed in a state before the torque sensor 4 is arranged around the rotating shaft 2, or in a state in which the torque sensor 4 is arranged around the rotating shaft 2 but no torque is being applied to the rotating shaft 2.

The first reference temperature tₛ₁ and the second reference temperature tₛ₂ are two temperatures different from each other and appropriately selected from a temperature range in which the torque sensor 4 is normally used. The absolute value |tₛ₁−tₛ₂| of the difference between the first reference temperature tₛ₁ and the second reference temperature tₛ₂ is appropriately set depending on the use, usage environment, or the like of the torque sensor 4. The absolute value |tₛ₁−tₛ₂| of the difference between the first reference temperature tₛ₁ and the second reference temperature tₛ₂ is not limited to this, and can be greater than or equal to 10° C. and less than or equal to 190° C., and preferably greater than or equal to 60° C. and less than or equal to 130° C. The temperature range in which the torque sensor 4 is normally used is, but is not limited to, a range of about −20° C. to 120° C., for example. In this case, for example, the first reference temperature tₛ₁ can be set to the temperature at which the torque sensor 4 starts to be used, that is, room temperature, and the second reference temperature tₛ₂ can be set to any temperature in the high temperature range that the torque sensor 4 reaches during normal use. In the present example, the first reference temperature tₛ₁ is set to 20° C., and the second reference temperature tₛ₂ is set to 80° C.

More specifically, the torque sensor 4 for which the correction value is to be acquired is connected to a test device having the same configuration as external devices of the torque measuring device 1 (the oscillator 14, the voltmeter 15, the temperature measuring unit 16, and the torque calculating unit 17). The torque sensor 4 is placed in a test chamber, and the temperature in the test chamber (room temperature) is set to a first reference temperature tₛ₁. Then, the torque sensor 4 is left for a certain period of time until the temperature of the torque sensor 4 reaches the first reference temperature tₛ₁. After a certain period of time has elapsed, a predetermined AC voltage Vi is applied between contact points A and C by the oscillator 14, and the voltage between contact points B and D is detected by the voltmeter 15 as the output value Voₛ₁. Next, the room temperature is set to the second reference temperature tₛ₂, and the temperature of the torque sensor 4 is left for a certain period of time until the temperature of the torque sensor 4 reaches the second reference temperature tₛ₂. After a certain period of time has elapsed, a predetermined AC voltage Vi is applied between contact points A and C by the oscillator 14, and the voltage between contact points B and D is detected by the voltmeter 15 as the output value Voₛ₂. However, the order of measurements is not particularly limited, and the output value Voₛ₂ at the second reference temperature tₛ₂ may be measured first, and then the output value Voₛ₁ at the first reference temperature tₛ₁ may be measured.

Next, the output value Voₛ₁ at the first reference temperature tₛ₁ is set as a provisional correction value Ctₛ₁ at the first reference temperature tₛ₁, and the output value Voₛ₂ at the second reference temperature tₛ₂ is set as a provisional correction value Ctₛ₂ at the second reference temperature tₛ₂, and a process is performed to determine a provisional correction function f, which is a linear function that shows the relationship between the temperature t of the torque sensor 4, and the provisional correction value Ctₛ₁ at the first reference temperature tₛ₁ and the provisional correction value Ctₛ₂ at the second reference temperature tₛ₂.

The provisional correction function f is a linear function expressed by v=a×t+b (where a and b are constants) as shown in FIG. 7A.

Next, at least one non-reference temperature tₙ other than the first reference temperature tₛ₁ and the second reference temperature tₛ₂ is substituted into the provisional correction function f to obtain a provisional correction value Ctₙ at the at least one non-reference temperature tₙ.

At least one non-reference temperature tₙ is appropriately set within the temperature range in which the torque sensor 4 is normally used, excluding the first reference temperature tₛ₁ and the second reference temperature tₛ₂. The number of non-reference temperatures tₙ can be set appropriately depending on the use or usage environment of the torque sensor 4, or the torque measurement accuracy required for the torque sensor 4. In a case in which the number of non-reference temperatures tₙ is one, the non-reference temperature tₙ can be set to, for example, an intermediate temperature between the first reference temperature tₛ₁ and the second reference temperature tₛ₂, but is not limited to this.

It is preferable to set a plurality of non-reference temperatures tₙ at regular intervals within the temperature range in which the torque sensor 4 is normally used, excluding the first reference temperature tₛ₁ and the second reference temperature tₛ₂. As the number of non-reference temperatures tₙ increases, the torque measurement accuracy of the torque sensor 4 can be improved. The number of non-reference temperatures tₙ is preferably three or more, and more preferably six or more. In a case in which the number of non-reference temperatures tₙ is three, the temperatures tₙ₁ can be set to, for example, any temperature lower than the first reference temperature tₛ₁ (for example, the lowest temperature in the range of use), the temperatures tₙ₂ can be set to an intermediate temperature between the first reference temperature tₛ₁ and the second reference temperature tₛ₂, and the temperatures tₙ₃ can be set to any temperature higher than the second reference temperature tₛ₂ (for example, the highest temperature in the range of use), although this is not limited to this.

There is no upper limit to the number of non-reference temperatures tₙ; however, in order to balance between ensuring the torque measurement accuracy and shortening the time required for testing to obtain a correction value, it is preferable to set the number of non-reference temperatures tₙ to 10 or less, and it is more preferable to set the number to 8 or less.

In the present example, the at least one non-reference temperature tₙ is set in the range of −20° C. to 120° C., with a total of six (tₙ₁ to tₙ₆) set at 20° C. intervals, excluding the first reference temperature tₛ₁, which is 20° C., and the second reference temperature tₛ₂, which is 80° C.

Next, a process of correcting the provisional correction value Ctₙ at the at least one non-reference temperature tₙ by a correction amount ΔCₙ at the at least one non-reference temperature tₙ that has been obtained in advance is performed to obtain a correction value Cₙ at the at least one non-reference temperature tₙ. More specifically, a correction amount ΔCₙ is added to the provisional correction value Ctₙ to obtain a correction value Cₙ (=Ctₙ+ΔCₙ).

In the present example, provisional correction values Ctₙ₁ to Ctₙ₆ at six non-reference temperatures tₙ₁ to tₙ₆ are corrected by correction amounts ΔCₙ₁ to ΔCₙ₆ at the six non-reference temperatures tₙ₁ to tₙ₆ that have been determined in advance, thereby obtaining correction values Cₙ₁ to Cₙ₆ [Cₙ₁ (=Ctₙ₁+ΔCₙ₁) to Cₙ₆ (=Ctₙ₆+ΔCₙ₆)] at the six non-reference temperatures tₙ₁ to tₙ₆, as shown in FIG. 7B.

The correction value Cₛ₁ at the first reference temperature tₛ₁ is a provisional correction value Ctₛ₁, that is, an output value Voₛ₁ at the first reference temperature tₛ₁ actually measured in a state before the torque sensor 4 is arranged around the rotating shaft 2. In addition, the correction value Cₛ₂ at the second reference temperature tₛ₂ is a provisional correction value Ctₛ₂, that is, an output value Voₛ₂ at the second reference temperature tₛ₂ actually measured in a state before the torque sensor 4 is arranged around the rotating shaft 2. That is, the correction amount ΔCₛ₁ at the first reference temperature tₛ₁ and the correction amount ΔCₛ₂ at the second reference temperature tₛ₂ are both zero.

The correction values (Cₛ₁, Cₛ₂, and Cₙ (Cₙ₁ to Cₙ₆)) obtained as described above are stored in a memory of a microcomputer having the torque calculating unit 17. Note that in cases where the torque calculating unit 17 is configured as an external device, before the torque sensor 4 is shipped from the manufacturing factory, a correction value Ct for each temperature t of the torque sensor 4 can be recorded on a recording medium 18 such as a two-dimensional code or an IC tag, and the recording medium 18 can be attached to a surface of the torque sensor 4 (the holder 5 or the magnetic ring 6).

It is necessary to obtain in advance a correction amount ΔCₙ at at least one non-reference temperature tₙ for correcting the provisional correction value Ctₙ at the at least one non-reference temperature tₙ. A method for determining the correction amount ΔCₙ in advance is arbitrary; however, is usually performed as advanced preparation by performing a preparatory test. The method for carrying out the preparatory test is also arbitrary; for example, the preparatory test can be performed as described below.

### Preparatory Test

As advanced preparation, a preparatory test is performed using at least one test sample having the same configuration as the torque sensor 4 for which a correction value is to be acquired. The number of test samples can be, but is not limited to, 1 to 10.

In the preparatory test, first, output values Eₛ₁, Eₛ₂, and Eₙ of the torque sensor 4 are measured at a first reference temperature tₛ₁, a second reference temperature tₛ₂, and at least one non-reference temperature tₙ for a test sample. In the present example, the output values Eₛ₁, Eₛ₂, Eₙ₁ to Eₙ₆ of the torque sensor 4 are actually measured at a first reference temperature tₛ₁, a second reference temperature tₛ₂, and six non-reference temperatures tₙ₁ to tₙ₆.

Measurement of the output values Eₛ₁, Eₛ₂, Eₙ₁ to Eₙ₆ is performed in a state in which the torque sensor 4 of the test sample is not arranged around the rotating shaft 2, or in a state in which the torque sensor 4 of the test sample is arranged around the rotating shaft 2 but no torque T is applied to the rotating shaft 2.

The first reference temperature tₛ₁, the second reference temperature tₛ₂, and at least one non-reference temperature tₙ in the preparatory test are set in the same manner in accordance with the method for acquiring a correction value for a torque sensor. In the present example, at least one non-reference temperature tₙ₁ to tₙ₆ is set in the range of −20° C. to 120° C., with a total of six temperatures set at intervals of 20° C., excluding the first reference temperature tₛ₁, which is 20° C., and the second reference temperature tₛ₂, which is 80° C.

In order to measure the output values Eₛ₁, Eₛ₂, and Eₙ (Eₙ₁ to Eₙ₆), the torque sensor 4 of the test sample is connected to a test device having the same configuration as the external devices of the torque measuring device 1 (oscillator 14, voltmeter 15, temperature measuring unit 16, and torque calculation unit 17), for example. The torque sensor 4 of the test sample is placed in a test chamber, and the temperature in the test chamber (room temperature) is set to a predetermined test temperature (first reference temperature tₛ₁, second reference temperature tₛ₂, or non-reference temperature tₙ (tₙ₁ to tₙ₆)), and the torque sensor 4 is left for a certain period of time until the temperature of the torque sensor 4 reaches the test temperature. After a certain time has elapsed, a predetermined AC voltage Vi is applied between contact points A and C by oscillator 14, and the voltage between contact points B and D is detected by the voltmeter 15 as the output values Eₛ₁, Eₛ₂, and Eₙ (Eₙ₁ to Eₙ₆). By repeatedly performing this process while changing the temperature in the test chamber, the output values Eₛ₁, Eₛ₂, and Eₙ (Eₙ₁ to Eₙ₆) of the torque sensor 4 are measured at the first reference temperature tₛ₁, the second reference temperature tₛ₂, and at least one non-reference temperature tₙ (tₙ₁ to tₙ₆).

In the preparatory test, the order of measurements is not particularly limited, and may be, for example, from low temperature to high temperature.

Next, the output value Eₛ₁ at the first reference temperature tₛ₁ is set as a provisional output value Etₛ₁, and the output value Eₛ₂ at the second reference temperature tₛ₂ is set as a provisional output value Etₛ₂, and a reference function f₀: Et=a₀×t+b₀ (a₀ and b₀ are constants), which is a linear function indicating the relationship between the temperature t, and the provisional output value Etₛ₁ and the provisional output value Etₛ₂ for the test sample, as shown in FIG. 6A, is obtained.

Next, the difference ΔEₙ (=Etₙ−Eₙ) between a provisional output value Etₙ at the at least one non-reference temperature tₙ obtained by substituting the at least one non-reference temperature tₙ into the reference function f₀ and the output value Eₙ actually measured at the at least one non-reference temperature tₙ is calculated. Based on this difference ΔEₙ, a correction amount ΔCₙ at the at least one non-reference temperature tₙ is calculated. The correction amount ΔCₛ₁ at the first reference temperature tₛ₁ and the correction amount ΔCₛ₂ at the second reference temperature tₛ₂ are both zero.

In the present example, as shown in FIG. 6B, the differences ΔEₙ₁ (=Etₙ₁−Eₙ₁) to ΔEₙ₆ (=Etₙ₆−Eₙ₆) between the provisional output values Etₙ₁ to Etₙ₆ at the six non-reference temperatures tₙ₁ to tₙ₆ and the output values Eₙ₁ to Eₙ₆ actually measured at the six non-reference temperatures tₙ₁ to tₙ₆ are calculated, and the correction amounts ΔCₙ₁ to ΔCₙ₆ at the six non-reference temperatures tₙ₁ to tₙ₆ are calculated based on these differences ΔEₙ₁ to ΔEₙ₆.

In a case in which the at least one test sample is composed of one test sample, the difference ΔEₙ (ΔEₙ₁ to ΔEₙ₆) obtained using the one test sample can be used as the correction amount ΔCₙ (ΔCₙ₁ to ΔCₙ₆) as is.

In a case in which the at least one test sample is composed of a plurality of test samples, the average value of the differences ΔEₙ (ΔEₙ₁ to ΔEₙ₆) calculated for each test sample can be used as the correction amount ΔCₙ (ΔCₙ₁ to ΔCₙ₆).

The above preparatory test does not need to be performed individually for each torque sensor 4 for which a correction value is to be acquired, and only needs to be performed once. That is, the correction amount ΔCₙ (ΔCₙ₁ to ΔCₙ₆) at at least one non-reference temperature tₙ (tₙ₁ to tₙ₆) obtained by the preparatory test can be commonly used for a torque sensor 4 having the same configuration as the test sample.

### Method for Calculating Torque Applied to a Rotating Shaft

In a case of determining the torque T applied to the rotating shaft 2 using the torque measuring device 1 equipped with the torque sensor 4 of the present example, the output value Vo of the torque sensor 4 arranged around the detected portion 3 of the rotating shaft 2 is corrected with the correction value C (Cₛ₁, Cₛ₂, and Cₙ (Cₙ₁ to Cₙ₆)) determined in advance as described above according to the temperature of the torque sensor 4, and the torque T of the rotating shaft 2 is calculated based on the corrected output value Vc.

More specifically, first, the output value Vo of the torque sensor 4 is detected by the voltmeter 15, and the temperature t of the torque sensor 4 is measured by the temperature measuring unit 16.

Next, the torque calculating unit 17 corrects the output value Vo by adding the correction value C (Cₛ₁, Cₛ₂, and Cₙ (Cₙ₁ to Cₙ₆)) at the temperature t of the torque sensor 4 to obtain a corrected output value Vc (=Vo+C).

Note that in a case in which the temperature t of the torque sensor 4 deviates from any of the first reference temperature tₛ₁, the second reference temperature tₛ₂, and at least one non-reference temperature tₙ (in the present example, the six non-reference temperatures tₙ₁ to tₙ₆), the output value Vo can be corrected using the correction value C at the closest temperature among the first reference temperature tₛ₁, the second reference temperature tₛ₂, and at least one non-reference temperature tₙ (tₙ₁ to tₙ₆). Alternatively, the output value Vo may be corrected using the average or weighted average of two temperatures among the first reference temperature tₛ₁, the second reference temperature tₛ₂, and at least one non-reference temperature tₙ (tₙ₁ to tₙ₆) that are closest to the temperature t of the torque sensor 4.

Note that in a case in which the temperature t of the torque sensor 4 is lower than the lowest temperature among the first reference temperature tₛ₁, the second reference temperature tₛ₂, and at least one non-reference temperature tₙ (tₙ₁ to tₙ₆), the output value Vo can be corrected using the correction value C at the lowest temperature. Alternatively, the correction value C at the temperature t of the torque sensor 4 can be obtained by adding the correction amount ΔC at the lowest temperature to a provisional correction value Ct obtained by substituting the temperature t of the torque sensor 4 into the provisional correction function f. In addition, in a case in which the temperature t of the torque sensor 4 is higher than the highest temperature among the first reference temperature tₛ₁, the second reference temperature tₛ₂, and at least one non-reference temperature tₙ (tₙ₁ to tₙ₆), the output value Vo can be corrected using the correction value C at the highest temperature. Alternatively, the correction value C at the temperature t of the torque sensor 4 can be obtained by adding the correction amount ΔC at the highest temperature to a provisional correction value Ct obtained by substituting the temperature t of the torque sensor 4 into the provisional correction function f.

The torque calculating unit 17, based on the corrected output value Vc, determines the magnitude T and direction (CW or CCW) of the torque applied to the rotating shaft 2 from the relationship between the output value V, which has been determined in advance by calculation, experiment, or the like, and the magnitude T and direction (CW or CCW) of the torque applied to the rotating shaft 2.

The torque measuring device 1 of the present example has a function for correcting for the effect of the temperature t of the torque sensor 4 on the output value Vo, and therefore can ensure good measurement accuracy of the torque T applied to the rotating shaft 2 regardless of the temperature t.

In particular, in the method for acquiring a correction value for the torque sensor 4 of the present example, in order to acquire the correction value C, the output values Voₛ₁ and Voₛ₂ are acquired at two temperatures, the first reference temperature tₛ₁ and the second reference temperature tₛ₂, for the torque sensor 4 for which the correction value is to be acquired. Therefore, it is easier to ensure good measurement accuracy of the torque T applied to the rotating shaft 2 compared to the conventional manufacturing method described in JP 2023-127315 A, in which tests to actually obtain output values are not performed for each individual torque sensor to be manufactured.

Furthermore, with the method for acquiring a correction value for the torque sensor 4 of the present example, by acquiring the output values Voₛ₁ and Voₛ₂ at two temperatures, the first reference temperature tₛ₁ and the second reference temperature tₛ₂, it is possible to obtain not only the correction values Cₛ₁ and Cₛ₂ at the first reference temperature tₛ₁ and the second reference temperature tₛ₂, but also the correction value Cₙ at at least one non-reference temperature tₙ. In other words, with the method for acquiring a correction value for the torque sensor 4 of the present example, it is not necessary to acquire output values at multiple (three or more) temperatures for each individual torque sensor while changing the temperature by a constant amount within the temperature range in which the torque sensor is normally used, as in the case with the conventional torque sensor described in JP 2018-048956 A. Therefore, with the method for acquiring a correction value for the torque sensor 4 of the present example, the time required for testing in order to acquire the correction value C can be shortened.

Note that in a case in which the voltmeter 15 detects the sine component and the cosine component of the output voltage as the output value of the torque sensor 4, and the torque calculating unit 17 is configured to calculate the torque T applied to the rotating shaft 2 based on the sine component and the cosine component, the correction value C can also be determined by dividing the correction value into a sine component and a cosine component. In a case in which the torque calculation unit 17 is configured to calculate the torque T applied to the rotating shaft 2 based on only the sine component or only the cosine component of the output voltage of the torque sensor 4 as the output value, the correction value C can also be obtained for only the sine component or only the cosine component.

### REFERENCE SIGNS LIST

1 Torque measuring device
2 Rotating shaft
3 Detected portion
4 Torque sensor
5 Holder
6 Magnetic ring
7 Bobbin portion
8 First outward-facing flange portion
9 Second outward-facing flange portion
10 Detection coil
10a First detection coil
10b Second detection coil
10c Third detection coil
10d Fourth detection coil
11 Flexible substrate
12a to 12d Coil piece
13 Bridge circuit
14 Oscillator
15 Voltmeter
16 Temperature measuring unit
17 Torque calculating unit
18 Recording medium
100 Bridge circuit
101 Rotating shaft
102 Detected portion
103 First detection coil
104 Second detection coil
105 Third detection coil
106 Fourth detection coil

1. A method for acquiring a correction value for a torque sensor arranged around a detected portion of a rotating shaft;
the method comprising steps of:
measuring an output value at a first reference temperature and an output value at a second reference temperature of the torque sensor for which the correction value is to be acquired;
determining a provisional correction function that is a linear function indicating a relationship between a temperature, and a provisional correction value at the first reference temperature and a provisional correction value at the second reference temperature for the torque sensor for which the correction value is to be acquired, with using an output value at the first reference temperature as the provisional correction value at the first reference temperature and an output value at the second reference temperature as the provisional correction value at the second reference temperature;
substituting at least one non-reference temperature other than the first reference temperature and the second reference temperature into the provisional correction function to obtain a provisional correction value at the at least one non-reference temperature; and
obtaining a correction value at the at least one non-reference temperature by correcting the provisional correction value at the at least one non-reference temperature by a correction amount at the at least one non-reference temperature that has been obtained in advance.

2. The method for acquiring a correction value for a torque sensor according to claim 1, wherein
the correction amount at the at least one non-reference temperature is found by:
Actually measuring an output value at the first reference temperature, an output value at the second reference temperature, and an output value at the at least one non-reference temperature for at least one test sample having a same configuration as the torque sensor for which the correction value is to be acquired;
determining a reference function that is a linear function indicating a relationship between a temperature, and a provisional output value at the first reference temperature and a provisional output value at the second reference temperature for the at least one test sample, with using the output value at the first reference temperature as the provisional output value and the output value at the second reference temperature as the provisional output value; and
obtaining a difference between the provisional output value at the at least one non-reference temperature obtained by substituting the at least one non-reference temperature into the reference function, and the actually measured output value at the at least one non-reference temperature.

3. The method for acquiring a correction value for a torque sensor according to claim 1, wherein an absolute value of a difference between the first reference temperature and the second reference temperature is 10° C. or more and 190° C. or less.

4. A method for measuring torque of a rotating shaft, comprising:
correcting an output value of a torque sensor arranged around a detected portion of the rotating shaft with a correction value determined in advance in accordance with a temperature of the torque sensor; and calculating torque applied to the rotating shaft based on the corrected output value of the torque sensor; wherein
the correction value is acquired by the method for acquiring a correction value for a torque sensor according to claim 1.
